(19) United States
(12) Patent Application Publication
(10) Pub. No.: US 2025/0162568 A1
(43) Pub. Date: May 22, 2025

(54) ELECTRIC VEHICLE POWERTRAIN CONTROL ALGORITHM

(71) Applicant: Gillig LLC, Livermore, CA (US)

(72) Inventors: Michael Cody Wampler, Windsor, CO (US); Samantha Marie White, Loveland, CO (US); William Briggs, Loveland, CO (US); Keith Lehmeier, Fort Collins, CO (US); Matthew Bulow, Loveland, CO (US); Michael Corona, Fort Collins, CO (US)

(21) Appl. No.: 18/956,411

(22) Filed: Nov. 22, 2024

Related U.S. Application Data
(60) Provisional application No. 63/602,181, filed on Nov. 22, 2023.

(51) Int. Cl. B60W 10/08; B60W 10/18

(52) U.S. Cl. CPC B60W 10/08; B60W 10/18; B60W 2520/10; B60W 2540/10; B60W 2540/12

(57) ABSTRACT

An electric vehicle comprises a drive motor coupled with a vehicle wheel, a brake subsystem to apply a braking force based on an amount of an engagement of a braking input, and a control subsystem. The control subsystem is configured to detect an amount of an engagement of a torque input, control the drive motor to apply an amount of the driving torque to the vehicle wheel based on the amount of an engagement of the torque input, determine a target creeping speed, detect amount of an engagement of the braking input by the driver, calculate an amount of a creeping torque, and, subsequent to detecting the amount of the engagement of the braking input and prior to detecting any engagement of the torque input by the driver, control the drive motor to apply the amount of the creeping torque to the vehicle wheel via the drive motor.

### CROSS-REFERENCE TO RELATED APPLICATIONS

The present invention claims the benefit to and priority of U.S. Provisional Application No. 63/602,181, filed Nov. 22, 2023. The entire disclosure of the above application is incorporated herein by reference.

### TECHNICAL FIELD

The technology disclosed herein relates generally to electric vehicles and control algorithms for monitoring and managing powertrain operations thereof.

### BACKGROUND

Powertrains and motors of electric vehicles (EVs) differ from internal combustion engines (ICEs) in a number of ways. In one context, while operating a gas-powered vehicle at low speeds or from a stopped position, losses occurring in an ICE of a gas-powered vehicle may propel the vehicle forward even when a driver does not provide any input using an accelerator pedal. Importantly, this may allow a gas-powered vehicle to creep forward at low speeds. EV powertrains and motors do not incur such losses, so this motion may not occur in an EV at stops or low speeds.

Further, torque applied to the drive motors is typically commanded in response to the position of the accelerator pedal among other factors experienced by or affecting the EV. As such, if the accelerator pedal is not being engaged by the driver, no propulsion torque is commanded to the drive motors. On a flat surface and with no propulsion torque applied to the drive motors due to the driver not engaging the brake or accelerator pedals, the powertrain can behave as if the EV were effectively in neutral even if the powertrain selector is in a drive mode. Thus, the EV is allowed to roll freely in response to the application of an external force acting to propel the vehicle forward or backward. Thus, with no movement of the EV due to engagement with the accelerator pedal, the driver to have a false sense of vehicle security and may exit the vehicle without securing the wheels from movement such as having the powertrain positioned in the parked mode.

### SUMMARY

Disclosed herein are improvements to electric vehicle (EV) powertrain control algorithms, and more particularly, to algorithms for controlling the torque produced by the EV.

In accordance with one aspect of the present disclosure, an electric vehicle (EV), comprises a vehicle wheel, a drive subsystem comprising a drive motor coupled with the vehicle wheel and configured to produce a driving torque applied to the vehicle wheel to drive the EV, a brake subsystem configured to apply a braking force to brake the vehicle wheel based on an amount of an engagement of a braking input by a driver, and a control subsystem coupled to the drive subsystem and to the brake subsystem. The control subsystem is configured to detect an amount of an engagement of a torque input by the driver, control the drive motor to apply an amount of the driving torque to the vehicle wheel based on the amount of an engagement of the torque input, determine a target creeping speed, detect amount of an engagement of the braking input by the driver, calculate an amount of a creeping torque based on the target creeping speed and the amount of the engagement of the braking input, and, subsequent to detecting the amount of the engagement of the braking input and prior to detecting any engagement of the torque input by the driver, control the drive motor to apply the amount of the creeping torque to the vehicle wheel via the drive motor.

In accordance with another aspect of the present disclosure, a method of propelling an electric vehicle (EV) including a driving wheel, a drive subsystem comprising a drive motor, a brake subsystem configured to apply a braking force to brake the driving wheel, and a control subsystem. The method comprises applying a driving torque to the driving wheel sufficient to propel the EV in a drive direction in response to engagement of a propulsion input by a driver, determining a target creeping speed, sensing a level of engagement of the brake subsystem by the driver, applying a creeping torque to the driving wheel sufficient to propel the EV in the drive direction based on the level of engagement and based on a lack of the engagement of the propulsion input by the driver subsequent to sensing the level of engagement of the brake subsystem, determining a speed of the EV in response to the application of the creeping torque, and adjusting the creeping torque based on the determined speed of the EV being different than the target creeping speed.

In accordance with yet another aspect of the present disclosure, an electric vehicle (EV), comprises a drive subsystem and a control subsystem. The drive subsystem comprises a drive motor. The control subsystem comprises an accelerator pedal sensor configured to sense a plurality of accelerator pedal positions of an accelerator pedal, the plurality of accelerator pedal positions comprising an accelerator pedal home position and a plurality of accelerator pedal engagement positions. The control subsystem also comprises a brake pedal sensor configured to sense a plurality of brake pedal positions of a brake pedal, the plurality of brake pedal positions comprising a brake pedal home position and a plurality of brake pedal engagement positions. The control subsystem also comprises a controller configured to sense a first accelerator pedal engagement position of the plurality of accelerator pedal engagement positions via the accelerator pedal sensor and, in response to sensing the first accelerator pedal engagement position, cause the drive motor to produce a driving torque sufficient to propel the EV in a drive direction. The controller is further configured to sense the brake pedal home position, sense the accelerator pedal home position, and, in response to sensing the brake pedal home position and the accelerator pedal home position, cause the drive motor to produce a creeping torque sufficient to propel the EV in a drive direction. The controller is further configured to adjust the creeping torque to cause the EV to be propelled at a constant creeping speed.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

The drawings illustrate embodiments presently contemplated for carrying out the invention.

In the drawings:

FIG. 1 illustrates a block diagram of an EV in accordance with an embodiment.

FIG. 2 illustrates a block diagram of an EV in accordance with another embodiment.

FIG. 3 illustrates a flowchart showing a method of operating the EV of FIG. 1 according to a vehicle driving mode in accordance with an embodiment.

FIG. 4

FIG. 5 illustrates a flowchart showing a method of operating the EV of FIG. 1 according to a vehicle creep mode in accordance with an embodiment.

FIG. 6 illustrates multiple plots showing operation of the EV of FIG. 1 according to a vehicle creep mode in accordance with an embodiment.

FIG. 7 illustrates multiple plots showing operation of the EV of FIG. 1 according to a vehicle creep mode in accordance with another embodiment.

FIG. 8 illustrates an example operating environment including the EV of FIG. 1 performing a powertrain control algorithm in accordance with an embodiment.

FIG. 9 illustrates a plot showing a relationship between a creeping torque limit and an inclination angle in accordance with an embodiment.

FIG. 10 illustrates a plot showing a relationship between a creeping speed and an inclination angle in accordance with an embodiment.

FIG. 11 illustrates a computing system suitable for implementing the various operational environments, architectures, processes, scenarios, and sequences discussed below with respect to the other Figures.

The drawings are not necessarily drawn to scale. In the drawings, like reference numerals designate corresponding parts throughout the several views. In some embodiments, components or operations may be separated into different blocks or may be combined into a single block.

### DETAILED DESCRIPTION

Although the disclosure hereof is detailed and exact to enable those skilled in the art to practice the invention, the physical embodiments herein disclosed merely exemplify the invention which may be embodied in other specific structures. While the preferred embodiment has been described, the details may be changed without departing from the invention, which is defined by the claims.

Discussed herein are enhanced components, techniques, and systems related to powertrain control algorithms of an electric vehicle (EV). EVs often utilize a wide range of control algorithms to meet various safety and functional requirements. One example algorithm may include functions to cause movement of the EV at a creeping speed (also referred to as a creep speed) during or after engagement of a brake subsystem by a driver even though no accelerator is subsequently engaged by the driver. Such movement may remind the driver that the EV has not been put into a park mode or that the parking brake has not been engaged.

Disclosed herein are improved control algorithms for low-speed powertrain operations. The proposed algorithms operate within the bounds of the powertrain for when the driver is not providing input via the accelerator. Advantageously, the methods, systems, and devices disclosed herein can monitor and regulate the torque produced by the powertrain of an EV based on factors, such as current environmental conditions and capabilities of the powertrain. As a result, by utilizing such algorithms, the EV may remain in motion (whenever the driver is providing little or no input via the brake pedal) at low speeds or following a full stop to zero miles per hour (MPH), so a driver may be cognizant that the EV is not parked or stalled.

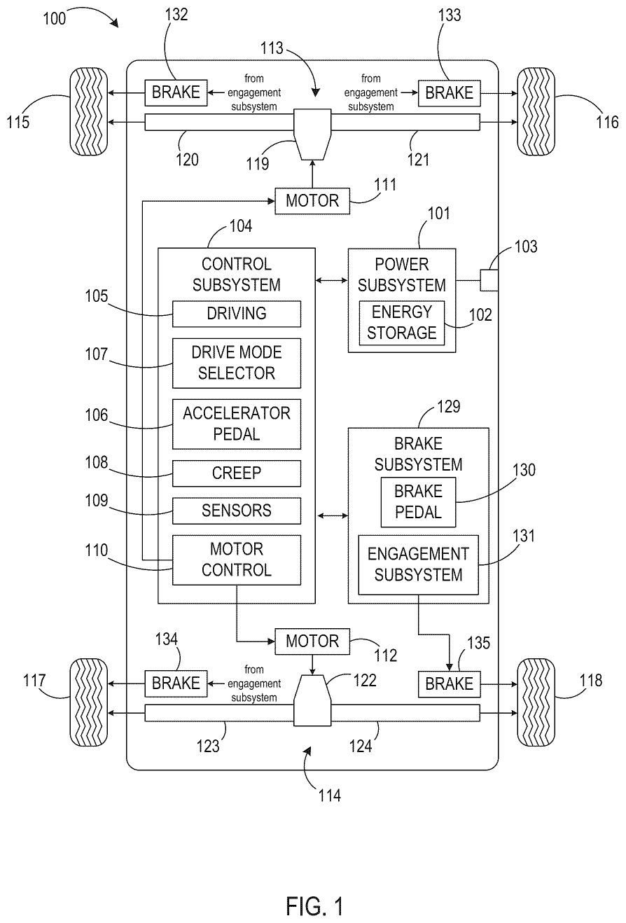

Now turning to the figures, FIG. 1 illustrates a block diagram of an electric vehicle (EV) 100 according to one or more aspects of this disclosure. The EV 100 includes a power subsystem 101 configured to store and deliver power throughout the EV 100. An energy storage 102 such as a plurality of rechargeable battery cells stores charging energy supplied through a charge port 103 via a charging station (not shown). The power subsystem 101 is coupled to a control subsystem 104 for powering a plurality of functions for propelling or driving the EV 100. The control subsystem 104 may be representative of one or more processors, processing systems or devices, or processing circuitry configured to execute control algorithms related to powertrain functionality, such as torque control or motor control. Examples of the processors include a general processing unit, a central processing unit (CPU), a microcontroller, a programmable logic controller, a digital signal processor, an application-specific integrated circuit (ASIC), field-programmable logic devices, and the like, as well as any combination or variation thereof.

A driving protocol 105 is configured to control driving the EV 100 in a desired direction as controlled by a driver or user engaging a torque input such as an accelerator pedal 106. References to the accelerator pedal 106 or to a driver's interaction with the accelerator pedal 106 will be understood to apply to any torque input engageable by the driver and should not be considered to be limited to an accelerator pedal only.

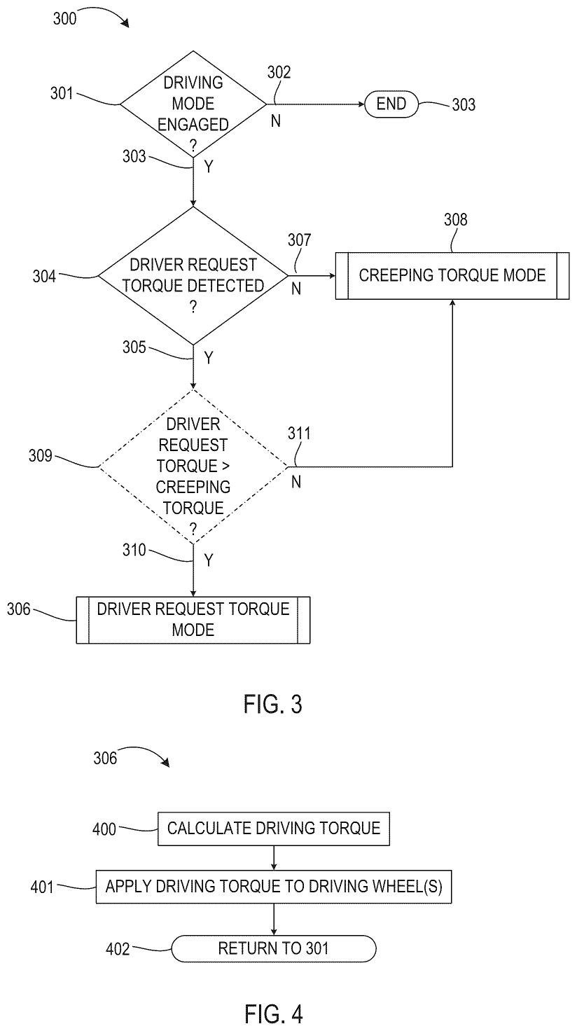

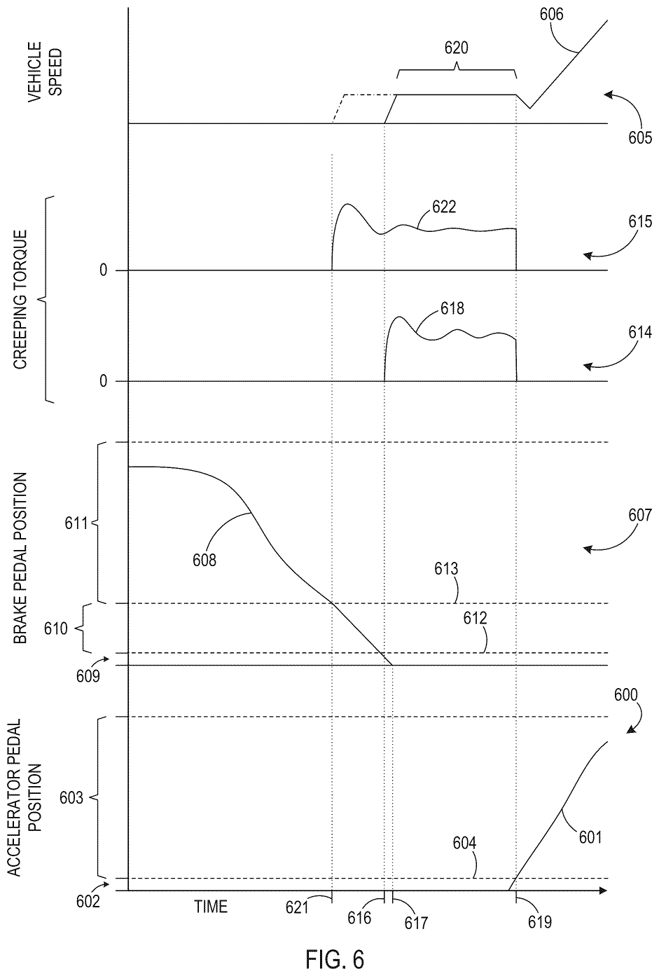

The direction of travel is selected by a drive mode selector 107 that provides standard mode selections to the user such as park, reverse, neutral, and drive. Driving modes include drive and reverse while non-driving modes include park and neutral. Additional selections may be presented based on alternative traction control methods in an example. A method of controlling the EV 100 in a driving mode is discussed with respect to FIG. 3. A vehicle creeping protocol 108 is configured, as described herein, to control a speed of the EV 100 in the absence of engagement of the accelerator pedal 106 by the driver while the driving mode of the EV 100 is selected. Control of the EV 100 based on a creeping torque (or creep torque) is described in FIGS. 6-10.

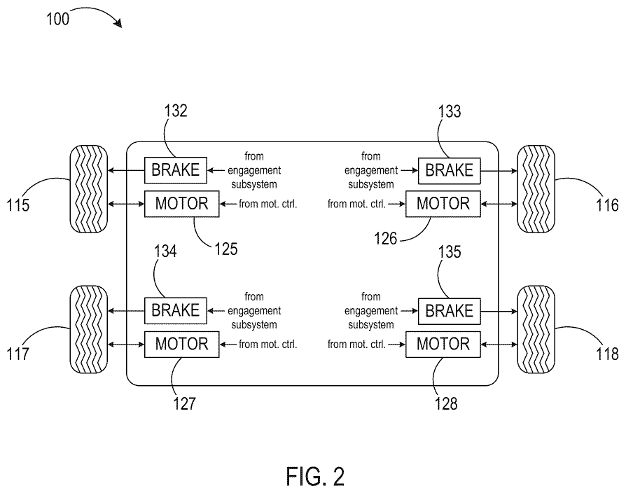

A plurality of sensors 109 is included in the control subsystem 104 to sense various aspect of propulsion control based on user interaction or based on automatic systems as described herein. A drive motor control protocol 110 is configured to control one or more drive motors 111, 112 to generate torques capable of propelling the EV 100 in the desired drive direction. The drive direction may be in a forward direction in response to the drive mode selected by the drive mode selector 107 and maybe in a backward direction in response to the reverse mode selected by the drive mode selector 107. As illustrated in FIG. 1, the EV 100 includes the pair of drive motors 111, 112 coupled to respective axle assemblies 113, 114 for driving wheels 115-118. The axle assembly 113 includes a differential 119, coupled to a pair of axles 120, 121. Axle 120 is coupled to drive wheel 115, and axle 121 is coupled to drive wheel 116. The axle assembly 114 includes a differential 122 coupled to a pair of axles 123, 124 that are coupled to respective wheels 117, 118. While two drive motors 111, 112 and axle assemblies 113, 114 are shown, the EV 100 may have only one drive motor with its associated axle assembly (e.g., drive motor 111 and axle assembly 113). For example, in an alternative embodiment as shown in FIG. 2, the EV 100 may not include either axle assembly 113, 114 and may instead include an individual drive motor 125-128 coupled a respective wheel 115-118.

Returning to FIG. 1, a brake subsystem 129 includes a user input such as a brake pedal 130 configured to drive a braking engagement subsystem 131 coupled to brakes 132-135 at each respective wheel 115-118. The braking engagement subsystem 131 may be, in some embodiments, a hydraulic system, a pneumatic system, an electrical system, or the like. Thus, in the embodiment illustrated, the brake subsystem 129 includes manually engaged brakes that are not controlled through electronic means. However, embodiments of this disclosure contemplate the use of electronically engaged brakes. Rather than engaging a hydraulic subsystem, a brake pedal of an electronically engaged brake subsystem may rely on a sensor sensing the position of the brake pedal and controlling electronic brakes coupled to the wheels based on the sensed pedal position.

A flowchart showing a method 300 of operating of the EV of FIG. 1 according to a vehicle driving mode is illustrated in FIG. 3 in accordance with an embodiment. The driving mode method 300 may be executed and controlled via the control subsystem 104, for example. Referring to FIGS. 1 and 3, the driving mode process 300 starts at step 301 with determining whether a driving mode is engaged by the drive mode selector 107, for example. The driving mode may be engaged by a position of the drive mode selector 107. For example, the driver may interact with the drive mode selector 107 to choose forward or reverse propulsion modes (e.g., “drive” or “reverse”). In response to a non-driving mode being detected at 301, the method 300 ends the vehicle driving mode at step 302.

While the driving mode is engaged (at 303), the method 300 detects, at step 304, whether a driver request torque has been detected. The driver request torque may be detected electronically by detecting a position of the accelerator pedal 106, for example, or by detecting another driver-engaged input for setting the driver request torque. According to a traditional use, the accelerator pedal 106 is activated by the driver's foot in the footwell of the driver's seat and includes a home position and a plurality of engagement positions. In a preferred embodiment, engagement of the accelerator pedal 106 by the driver is counteracted by an accelerator return mechanism such as a spring such that a disengagement of the accelerator pedal 106 by the driver returns the accelerator pedal 106 to its home position. In alternate embodiments, other types of user inputs not actuated by the driver's foot may be used to determing the target driving torque. Based on the position of the accelerator pedal 106 not being at its home position and being in one of the engagement positions, the driver request torque is detected at step 304.

In response to detecting a driver request torque (at 305), a driving request torque mode procedure 306 is executed. The driving request torque mode procedure 306 is further defined in FIG. 4, which includes, at step 400, calculation of a driving torque based on the driver requested torque. Calculating the driving torque may include calculating an energy to be produced in inverter(s) coupled to drive motor(s) that when supplied to the drive motor(s), the energy causes the driver motor(s) to produce the calculated torque. The inverter(s) is caused to control the drive motor(s) at step 401 to cause the calculated driving torque to be applied to the drive wheel(s) coupled with the drive motor(s).

After step 401, process control returns (at step 402) to step 301 of the method 300 of FIG. 3 to re-test for detecting engagement of a driving mode. While a driving mode is engaged and a driver requested torque is detected, steps 301, 304, and 306 repeat as described above. The driver may manipulate the drive mode selector 107 to select a desired driving mode in one example, However, in another example, an automatic process independent of the driver may cause a different driving mode to be selected such that the method 300 may be interrupted or canceled as appropriate.

Returning to FIG. 3, while at the home position, the accelerator pedal 106 does not indicate any driver request torque. As such, if the accelerator pedal 106 is in the home position while the step 304 of detecting the driver request torque is executed, no driver request torque will be detected. In other words, the accelerator pedal 106 indicates zero driver request torque when in the home position. As shown, if a driver request torque is not detected (at 307) via the detection step 304, a creeping torque mode procedure 308 is executed.

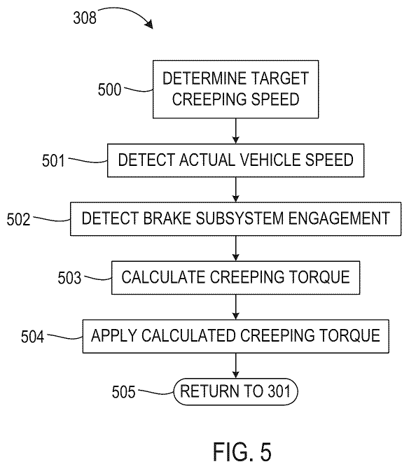

FIG. 5 illustrates a flowchart showing a method of operating a vehicle according to the creeping torque mode procedure 308 in accordance with an embodiment. Referring to FIGS. 5 and 1, the creeping torque mode procedure 308 begins by gathering a plurality of parameters. A first parameter of a target creeping speed is determined at step 500. The target creeping speed is a constant speed target to which the creeping torque mode procedure 308 aims to propel the EV 100 and may be determined by referencing a lookup table, for example. On a level driving surface, the constant speed target may be set to a value of 1 or 2 miles per hour or to another value as best fits a given scenario as determined by a system designer. As described below with respect to FIG. 10, the constant speed target may be affected by a level of inclination of the EV 100.

A second parameter of an actual traveling speed of the of the vehicle is detected or determined at step 501. The actual traveling speed may be determined, for example, by a wheel rotation sensor or a ground speed sensor of the plurality of sensors 109 as a feedback provided to the control subsystem 104.

A third parameter of a level of engagement of the brake subsystem 129 is detected or determined at step 502. The brake subsystem engagement may be detected based on a position of the brake pedal 130. According to a traditional use, the brake pedal 130 is activated by the driver's foot in the footwell of the driver's seat and includes a home position and a plurality of engagement positions. In a preferred embodiment, engagement of the brake pedal 130 by the driver is counteracted by a brake return mechanism such as a spring such that a disengagement of the brake pedal 130 by the driver returns the brake pedal 130 to its home position. Based on the position of the brake pedal 130 being at its home position, a level of zero engagement is detected. Based on the position of the brake pedal 130 not being at its home position and being in one of the engagement positions, a level of engagement greater than zero is detected.

Based at least on the three parameters of the target creeping speed, the actual traveling speed, and the level of brake subsystem engagement, an amount of a creeping torque can be calculated at step 503. In response to detecting no level of driver engagement with the brake subsystem, the amount of creeping torque is calculated to produce a constant creeping speed of the vehicle at the target creeping speed. A comparison between the detected actual vehicle speed and the target creeping speed is used to calculate the creeping torque necessary to produce the constant creeping speed. In one example, an actual vehicle speed greater than the target creeping speed may cause an amount of zero creeping torque to be calculated. In this manner and in response to road conditions such as incline and other factors, the vehicle may be allowed to coast to a slower speed while the actual speed remains above the target creeping speed. In another example, the actual vehicle speed being less than the target creeping speed may cause an amount of creeping torque to be calculated based on propelling the vehicle at a constant creeping speed equal to the target creeping speed.

In a first embodiment, any amount of driver engagement with the brake subsystem greater than zero detected at step 502 causes zero amount of creeping torque to be calculated. This can override any calculation of creeping torque based on the actual vehicle speed being less than the target creeping speed. In this manner, any engagement of the brake pedal 130 by the driver beyond the brake pedal home position disengages the application of any creeping torque during methods 300 and 400.

In a second embodiment, in response to detecting some driver engagement with the brake subsystem beyond the home position, an amount of the creeping torque may be calculated based on the level of driver engagement with the brake subsystem being less than a brake engagement threshold. In one example, the brake engagement threshold indicates a position of the brake pedal 130 at which a sufficient braking force is applied to the drive wheel(s) that would prevent the drive wheel(s) from rotating during the application of a creeping torque that is calculated as described herein. As such, at an engagement level greater than zero and below the brake engagement threshold, some braking force is applied to the drive wheel(s), but the amount of creeping torque calculated and applied to the drive wheel(s) is sufficient to overcome the applied braking force and causes the EV 100 to have some velocity. The calculation of the amount of creeping torque may be based on the target creeping speed determined at step 500 in one example. In another example, the target creeping speed may be modified by the amount of brake subsystem engagement. For example, modification of the target creeping speed may result in a lower value at higher levels of brake subsystem engagement and higher creeping speed values at lower levels of brake subsystem engagement.

Based on the amount of creeping torque calculated at step 503, the inverter(s) coupled to the drive motor(s) is caused to control the drive motor(s) to apply the calculated creeping torque to the drive wheel(s) at step 504. After step 504, process control returns (at step 505) to step 301 of the method 300 of FIG. 3 to re-test for detecting engagement of a driving mode. While a driving mode is engaged and no driver requested torque is detected, steps 301, 304, and 308 repeat as described above.

The method 300 can be configured to maintain iteration of steps 301, 304, and 308 for an indefinite time while no driver engagement with the accelerator pedal 106 is detected with no other additional factors terminating the process. For example, the iterations can remain in execution while sufficient power from the power subsystem 101 provides sufficient power to propel the vehicle based on the calculated creeping torque values. As such, the vehicle is allowed to travel for many miles under creeping torque propulsion. Also, if an obstacle avoidance subsystem determines a cause for stopping the vehicle, the process 300 may be maintained. Alternatively, a timeout delay may be set to end the process 300 upon termination of the timeout delay.

FIG. 6 illustrates multiple plots showing positions, torques, and speed in an example embodiment based on the methods 300, 400, and 500 described herein. Referring to FIGS. 1 and 3-6, an accelerator pedal position graph 600 shows an exemplary accelerator pedal position waveform 601 detected by a pedal position sensor of the plurality of sensors 109. A first position zone 602 represents a home position of the accelerator pedal 106. A second position zone 603 represents positions of the accelerator pedal 106 detectable as engagement positions. A driver engagement with the accelerator pedal 106 results in engagement positions within the position zone 603 being detectable by the pedal position sensor. As discussed above, a return mechanism such as a spring may return the accelerator pedal 106 to the home position zone 602 in response to disengagement by the driver. A home position threshold 604 represents an accelerator pedal position beyond an initial play in the accelerator pedal 106 at which accelerator pedal engagement position within the second position zone 603 may be detected. A driving speed graph 605 correlating to the accelerator pedal position graph 600 is illustrated showing a driving speed waveform 606 responsive, in one embodiment, to the driving speed of the EV 100 pursuant to the driving method 300 discussed above.

A brake pedal position graph 607 shows an exemplary brake pedal position waveform 608 detected by a brake position sensor of the plurality of sensors 109. A first position zone 609 represents a home position of the brake pedal 130. A plurality of engagement positions are illustrated above the home position zone 609 including positions within a first engagement zone 610 and within a second engagement zone 611. A home position threshold 612 is shown at the border between the home position zone 609 and the first engagement zone 610. The first home position threshold 612 represents a brake pedal position beyond an initial play in the brake pedal 130 at which brake engagement positions beyond the home position zone 609 may be detected. A brake engagement threshold 613 between the first and second engagement zones 610, 611 is identified. The brake pedal position waveform 608 shows an engagement of the brake subsystem 129 by the driver as the various brake pedal positions represented by the waveform 608 are measured or sensed over time.

A plurality of creeping torque graphs 614-615 are also shown, each representing an alternative response to the application of a creeping torque to the drive wheel(s) as will be discussed below.

In a first embodiment, propulsion of the EV 100 via the creeping torque mode procedure 308 of method 300 occurs only if an engagement position of the brake pedal 130 is detected to be at the home position zone 609. For example, the driver may be disengaged from the brake pedal 130 or may be in contact with the brake pedal 130 without applying a sufficient force to cause the brake pedal 130 to be moved beyond its home position. In this first embodiment, detected brake subsystem engagement beyond the home position zone 609 results from the engagement position of the brake pedal 130 being within either of the first or second engagement zones 610, 611. In an example under this first embodiment, an amount of brake pedal engagement equal to zero can be determined between time points 616 or 617. Accordingly, the position of the brake pedal 130 is outside either of the first or second engagement zones 610, 611 between time points 616 and 617 and beyond as illustrated in FIG. 6.

In response to detecting the position of the brake pedal 130 being within home position zone 609 and the position of the accelerator pedal 106 being within the position zone 602 in this first embodiment, execution of methods 300 and 500 described in FIGS. 3 and 5 cause the calculated creeping torque (e.g., at step 503) to be applied (e.g., at step 504) as illustrated by the creeping torque waveform 618 of the creeping torque graph 614. As shown, the creeping torque waveform 618 begins at detection of zero engagement of the brake pedal 130 at time point 616 and ends due to the detection of a driver engagement with the accelerator pedal 106 beyond the position zone 602 in step 304 at time point 619, at which the driving request torque mode procedure 306 described with respect to FIG. 3 takes over. The variable torque value illustrated in the creeping torque waveform 618 is meant to indicate that the calculated creeping torque is varied or modified to keep the vehicle speed constant. For example, as illustrated in the driving speed graph 605, a constant speed zone 620 is maintained via the calculated creeping torque as described above with respect to FIG. 5.

According to a second embodiment, propulsion to the EV 100 via the creeping torque mode procedure 308 of method 300 as described above with respect to the first embodiment as well as in response to the detection of a level of engagement of the brake pedal 130 being greater than zero but below a value corresponding with the brake position threshold 613. In this second embodiment, a position of the accelerator pedal 106 within the first engagement zone 610 or within the home position zone 609 causes a creeping torque to be calculated. In an example under this second embodiment, an engagement level of the brake pedal 130 greater than zero can be determined between time points 621 and 616 while an engagement level of zero can be determined between time points 616 and 617 and beyond. A creeping torque waveform 622 of the creeping torque graph 615 illustrates example torques calculatable to maintain the constant speed of the driving speed waveform 606.

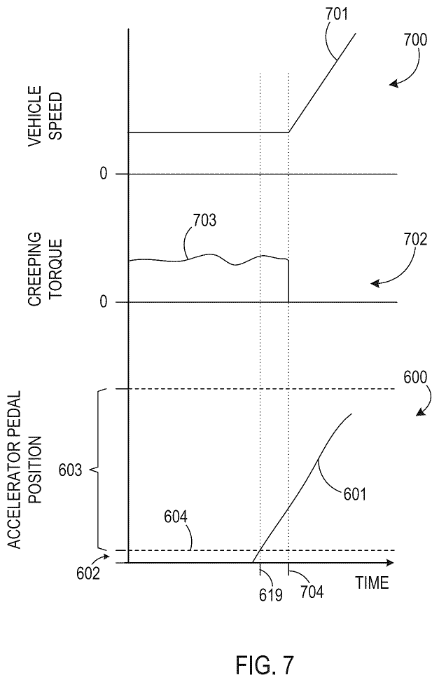

FIG. 7 illustrates multiple plots showing positions, torques, and speed in an example embodiment based on the methods 300, 400, and 500 described herein. The accelerator pedal position waveform 601 shown in FIG. 7 has been described above. A driving speed graph 700 is shown that includes a driving speed waveform 701. An alternative creeping torque graph 702 includes a creeping torque waveform 703 showing example calculated creeping torques applied to the drive wheel(s) during the creeping torque mode procedure 308. Unlike the creeping torque graph 614 of FIG. 6 that ends based on detecting, in step 304, engagement of the accelerator pedal 106 beyond the home position threshold 604 and outside of the position zone 602, the driving mode method 300 of FIG. 3 includes a step 309 (shown in phantom) for comparing the previously-calculated creeping torque value with a value of the driver request torque detected at step 304. If the driver request torque is greater than the creeping torque (at 310), the creeping torque mode procedure 308 is canceled, and the driving request torque mode procedure 306 is processed as described above. As shown in FIG. 7, engagement positions of the accelerator pedal 106 past a time point 704 yield sufficient driver request torque values to cause the driver request torque values to take over propulsion of the drive wheel(s) from the calculated creeping torque 703. Between time points 619 and 704, however, though there is some detected driver request torque values, step 309 of the driving mode method 300 does not determine (at 311) that the driver request torque is less than the calculated creeping torque, and, therefore, process control remains with the creeping torque mode procedure 308.

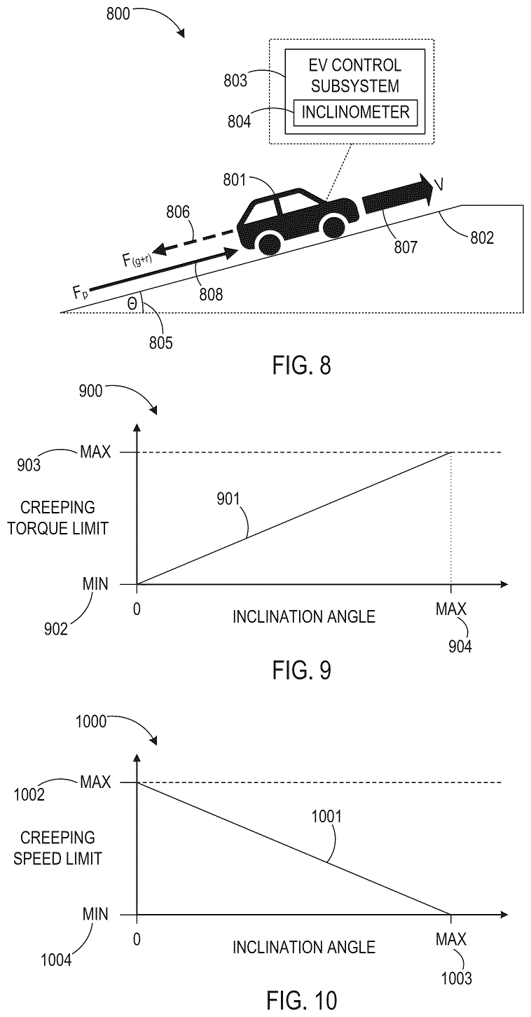

FIG. 8 illustrates an example operating environment 800 including an electric vehicle (EV) 801 capable of performing control algorithms in accordance with an embodiment. FIG. 8 displays operating environment 800, which includes EV 801 and incline 802. EV 801 is representative of any type of electric vehicle such as EV 100 described herein and includes the control, power, brake, and other subsystems of EV 100 configured to perform in the manner described above, such as performing the processes discussed above with respect to FIGS. 3-7. For example, EV 801 includes a control subsystem 803 similar to the control subsystem 104 of EV 100. In addition, however, the control subsystem 803 of EV 801 also includes an inclinometer 804 for use as described below.

In operating environment 800, EV 801 may be stopped on the incline 802 and facing uphill (e.g., to the right in the illustration shown in FIG. 8) when the driver disengages with the brake pedal 130, causing the creeping torque mode procedure 308 to begin its process. Incline 802 may be representative of an inclined street, a hill, a ramp, or the like. Incline 802 may have a pitch including a number of degrees greater than zero degrees but less than ninety degrees, as represented by angle 805. While EV 801 is positioned and operating on incline 802, angle 805 of incline 802 may influence the target creeping speed and subsequent creeping torque values determined at steps 500 and 503 of the creeping torque mode procedure 308 in order to overcome environmental conditions (e.g., force 806) and move EV 801 at a creeping velocity 807 up incline 802.

Propelling the EV 801 at a desired creeping speed up the incline 802 includes applying a sufficient creeping torque to yield a powertrain force 808 (denoted by Fp in FIG. 8) greater than the force 806 (denoted by Fg+r in FIG. 8). In response, the creeping velocity in the direction of intended motion 807 (denoted by V in FIG. 8) greater than zero will provide uphill propulsion.

FIG. 9 illustrates a plot 900 showing a relationship between a creeping torque limit and an inclination angle in accordance with an embodiment. Referring to FIGS. 8 and 9, an inclination angle 901 determined by sensing the inclination of the EV 801 via the inclinometer 804 has a relationship with values calculatable for the creeping torque in, for example, step 503 of the creeping torque mode procedure 308. For example, when positioned on a level surface, the amount of creeping torque required to propel the EV 801 in the driving direction at a target creeping speed is not as great as the amount of creeping torque needed to propel the EV 801 at the target creeping speed when the EV 100 is on an inclined surface. Thus, a limit to the creeping torque calculatable via the step 503 may be at a minimum value 902 in response to detecting no inclination angle via the inclinometer 804.

A maximum amount of available creeping torque 903 may be available, however, should the EV 801 be on a surface of maximum inclination 904. The amount of maximum inclination angle may be determined based on a number of factors such as an expected amount of power needed from the power subsystem 101 to produce the target creeping speed. Other factors may also determine the maximum inclination angle 904. Measured values higher than the maximum inclination angle 904, the control subsystem 803 may terminate any usage of the creeping torque mode procedure 308 to produce a creeping speed as described herein. In one embodiment, the absense of any detectable inclination angle 901 during the creeping torque mode procedure 308 may result in the minimum value 902 of the creeping torque being available for use.

In addition to determining a limit to the creeping torque calculatable in the creeping torque mode procedure 308, the inclinometer 804 may also be used to limit the target creeping speed. FIG. 10 illustrates a plot 1000 showing a relationship between a creeping speed and an inclination angle in accordance with an embodiment. Referring to FIGS. 8 and 10, an inclination angle 1001 determined by sensing the inclination of the EV 801 via the inclinometer 804 has a relationship with a target creeping speed available for determination in, for example, step 500 of the creeping torque mode procedure 308. When traveling uphill via propulsion according to the creeping torque mode procedure 308, it may be desirable to lower the target creeping speed to reduce the speed at which the EV 801 travels uphill. As such, a level surface (e.g., having an inclination angle of zero degrees) may support allowing the EV 801 to travel at the maximum creeping speed limit 1002. Inversely, a measured incline at the maximum inclination 1003 will limit the target creeping speed to a minimum value 1004. For example, the maximum target creeping speed limit 1002 may be set to 1 or 2 miles per hour as described above while the minimum target creeping speed value 1004 may be set to 0.5 miles per hour or less.

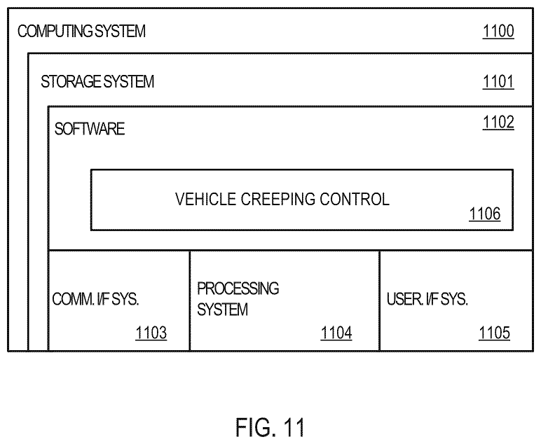

FIG. 11 illustrates a computing system 1100 to perform vehicle creeping control according to an implementation of the present technology. Computing system 1100 is representative of any system or collection of systems with which the various operational architectures, processes, scenarios, and sequences disclosed herein for performing vehicle creeping control processes may be employed. Computing system 1100 may be implemented as a single apparatus, system, or device or may be implemented in a distributed manner as multiple apparatuses, systems, or devices. Computing system 1100 includes, but is not limited to, storage system 1101, software 1102, communication interface system 1103, processing system 1104, and user interface system 1105 (optional). Processing system 1104 is operatively coupled with storage system 1101, communication interface system 1103, and user interface system 1105. Computing system 1100 may be representative of a cloud computing device, distributed computing device, or the like.

Processing system 1104 loads and executes software 1102 from storage system 1101. Software 1102 includes and implements vehicle creeping control 1106, which is representative of any of the methods described herein. When executed by processing system 1104 to control vehicle creep, software 1102 directs processing system 1104 to operate as described herein for at least the various processes, operational scenarios, and sequences discussed in the foregoing implementations. Computing system 1100 may optionally include additional devices, features, or functionality not discussed for purposes of brevity.

Referring still to FIG. 11, processing system 1104 may comprise a micro-processor and other circuitry that retrieves and executes software 1102 from storage system 1101. Processing system 1104 may be implemented within a single processing device but may also be distributed across multiple processing devices or sub-systems that cooperate in executing program instructions. Examples of processing system 1104 include general purpose central processing units, graphical processing units, application specific processors, and logic devices, as well as any other type of processing device, combinations, or variations thereof.

Storage system 1101 may comprise any computer readable storage media readable by processing system 1104 and capable of storing software 1102. Storage system 1101 may include volatile and nonvolatile, removable and non-removable media implemented in any method or technology for storage of information, such as computer readable instructions, data structures, program modules, or other data. Examples of storage media include random access memory, read only memory, magnetic disks, optical disks, optical media, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 1101 may also include computer readable communication media over which at least some of software 1102 may be communicated internally or externally. Storage system 1101 may be implemented as a single storage device but may also be implemented across multiple storage devices or sub-systems co-located or distributed relative to each other. Storage system 1101 may comprise additional elements, such as a controller capable of communicating with processing system 1104 or possibly other systems.

Software 1102 (including vehicle creeping control 1106) may be implemented in program instructions and among other functions may, when executed by processing system 1104, direct processing system 1104 to operate as described with respect to the various operational scenarios, sequences, and processes illustrated herein. For example, software 1102 may include program instructions for implementing vehicle creeping control processes as described herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 1102 may include additional processes, programs, or components, such as operating system software, virtualization software, or other application software. Software 1102 may also comprise firmware or some other form of machine-readable processing instructions executable by processing system 1104.

In general, software 1102 may, when loaded into processing system 1104 and executed, transform a suitable apparatus, system, or device (of which computing system 1100 is representative) overall from a general-purpose computing system into a special-purpose computing system customized to provide vehicle creeping control process performance as described herein. Indeed, encoding software 1102 on storage system 1101 may transform the physical structure of storage system 1101. The specific transformation of the physical structure may depend on various factors in different implementations of this description. Examples of such factors may include, but are not limited to, the technology used to implement the storage media of storage system 1101 and whether the computer-storage media are characterized as primary or secondary storage, as well as other factors.

For example, if the computer readable storage media are implemented as semiconductor-based memory, software 1102 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 1103 may include communication connections and devices that allow for communication with other computing systems (not shown) over communication networks (not shown). Examples of connections and devices that together allow for inter-system communication may include network interface cards, antennas, power amplifiers, radiofrequency circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication interface system 1103 may communicate with sensors and input devices such as the plurality of sensors 109 and velocity input (e.g., the accelerator pedal 106) of FIG. 1. Additionally, it is observable that the ambient temperature affects battery overpotential. Accordingly, communication interface system 1103 may also communicate with one or more temperature sensors (not shown) to compare observed changes with the ambient temperature. In one embodiment, temperature calibration curves may be included and consulted to help determine what behavior a given battery should exhibit at a given cycle and temperature.

Communication between computing system 1100 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of networks, or variation thereof. The aforementioned communication networks and protocols are well known and need not be discussed at length here.

While some examples provided herein are described in the context of an electric vehicle, system, subsystem, circuit, or environment, the systems, components, and methods described herein are not limited to such embodiments and may apply to a variety of other processes, systems, applications, devices, and the like. Aspects of the present invention may be embodied as a system, method, device, and other configurable systems.

Based on embodiments discussed above, a driver may be reminded that an EV remains positioned in one of the driving modes based on an automatic propulsion method based on applying a creeping torque to the wheels as described herein. The automatic propulsion method may apply the creeping torque based on a speed of the EV below a creeping speed threshold. The creeping speed threshold is not based on a user-selected speed though the accelerator pedal and may be active and ready to apply the creeping torque while the driving mode is selected. For example, the EV can be caused to travel at a creeping speed in response to the driver removing the driver's foot from the brake pedal and prior to interacting with the accelerator pedal. In this manner, the driver can be reminded that the vehicle remains in the drive mode should the disengagement with the brake pedal be in preparation for exiting the vehicle. The application of the creeping torque to the drive wheel(s) can be configured to apply the creeping torque without regard to a timer such that the creeping torque is applied as long as there is sufficient power from the power subsystem to provide energy to the driving motor. In this manner, the creeping torque may provide propulsion to move the vehicle many miles if left active. However, obstacle avoidance may intervene should an obstacle be detected to be within the path of the moving vehicle. In another embodiment, a timer may be employed to cancel the automatic creeping speed propulsion after a period of time. In addition, the movement of the vehicle at the creeping speed helps improve operability by providing better control during low-speed maneuvers.

Unless the context clearly requires otherwise, throughout the description and the claims, the words “comprise,” “comprising,” and the like are inclusive meaning “including, but not limited to.” In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A. A device that is “configured to” perform a task or function may be configured (e.g., programmed and/or hardwired) at a time of manufacturing by a manufacturer to perform the function and/or may be configurable (or reconfigurable) by a user after manufacturing to perform the function and/or other additional or alternative functions. The configuring may be through firmware and/or software programming of the device, through a construction and/or layout of hardware components and interconnections of the device, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The phrases “in some embodiments,” “according to some embodiments,” “in the embodiments shown,” “in other embodiments,” and the like generally mean the particular feature, structure, or characteristic following the phrase is included in at least one implementation of the present technology, and may be included in more than one implementation. In addition, such phrases do not necessarily refer to the same embodiments or different embodiments.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed or implemented in parallel or may be performed at different times. Further any specific numbers noted herein are only examples: alternative implementations may employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above, but also may include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. § 112(f) will begin with the words “means for” but use of the term “for” in any other context is not intended to invoke treatment under 35 U.S.C. § 112(f). Accordingly, the applicant reserves the right to pursue additional claims after filing this application to pursue such additional claim forms, in either this application or in a continuing application.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the present disclosure. Additionally, while various embodiments of the present disclosure have been described, it is to be understood that aspects of the present disclosure may include only some of the described embodiments. Accordingly, the invention is not to be seen as limited by the foregoing description but is only limited by the scope of the appended claims.

What is claimed is:

1. An electric vehicle (EV) comprising:
a vehicle wheel;
a drive subsystem comprising a drive motor coupled with the vehicle wheel and configured to produce a driving torque applied to the vehicle wheel to drive the EV;
a brake subsystem configured to apply a braking force to brake the vehicle wheel based on an amount of an engagement of a braking input by a driver; and
a control subsystem coupled to the drive subsystem and to the brake subsystem;
wherein the control subsystem is configured to:
detect an amount of an engagement of a torque input by the driver;
control the drive motor to apply an amount of the driving torque to the vehicle wheel based on the amount of an engagement of the torque input;
determine a target creeping speed;
detect amount of an engagement of the braking input by the driver;
calculate an amount of a creeping torque based on the target creeping speed and the amount of the engagement of the braking input; and
subsequent to detecting the amount of the engagement of the braking input and prior to detecting any engagement of the torque input by the driver, control the drive motor to apply the amount of the creeping torque to the vehicle wheel via the drive motor.

2. The EV of claim 1, wherein the control subsystem comprises an accelerator pedal configured to define the amount of engagement of the torque input by the driver.

3. The EV of claim 2, wherein the control subsystem further comprises an accelerator return mechanism coupled to the accelerator pedal and configured to return the accelerator pedal to a home position in response to a disengagement of the accelerator pedal by the driver.

4. The EV of claim 1, wherein the control subsystem is further configured to:
determine an actual speed of the vehicle wheel in response to the amount of the creeping torque applied to the vehicle wheel; and
control the drive motor to adjust the amount of the creeping torque applied to the vehicle wheel based on a comparison of the target creep speed with the actual speed.

5. The EV of claim 1, wherein the brake subsystem comprises:
a brake pedal configured to define the amount of the engagement of the braking input by the driver; and
a braking return mechanism coupled to the brake pedal and configured to return the brake pedal to a home position in response to a disengagement of the brake pedal by the driver.

6. The EV of claim 5, wherein the control subsystem is further configured to:
detect a position of the brake pedal; and
control the drive motor to apply the amount of the creeping torque to the vehicle wheel based on the detected position of the brake pedal being different than the home position and based on a difference between the position of the brake pedal and the home position being less than a braking threshold.

7. The EV of claim 6, wherein the amount of the creeping torque applied to the vehicle wheel is sufficient to overcome the amount of the braking force applied to the vehicle wheel.

8. The EV of claim 1, wherein the control subsystem is further configured to:
detect the engagement of the torque input by the driver after application of the amount of the creeping torque; and
control the drive motor to remove the application of the amount of the creeping torque in response to detecting the engagement of the torque input by the driver.

9. The EV of claim 1 further comprising:
an additional vehicle wheel;
a first axle coupled to the vehicle wheel;
a second axle coupled to the additional vehicle wheel; and
a differential coupled between the first and second axles;
wherein the drive motor is coupled to the differential.

10. A method of propelling an electric vehicle (EV) comprising a driving wheel, a drive subsystem comprising a drive motor, a brake subsystem configured to apply a braking force to brake the driving wheel, and a control subsystem, the method comprising:
applying a driving torque to the driving wheel sufficient to propel the EV in a drive direction in response to engagement of a propulsion input by a driver;
determining a target creeping speed;
sensing a level of engagement of the brake subsystem by the driver;
applying a creeping torque to the driving wheel sufficient to propel the EV in the drive direction based on the level of engagement and based on a lack of the engagement of the propulsion input by the driver subsequent to sensing the level of engagement of the brake subsystem;
determining a speed of the EV in response to the application of the creeping torque; and
adjusting the creeping torque based on the determined speed of the EV being different than the target creeping speed.

11. The method of claim 10 further comprising determining an amount of a driver request torque via the propulsion input; and
calculating the driving torque based on the amount of the driver request torque.

12. The method of claim 11, wherein the level of engagement of the brake subsystem by the driver causes a braking force to be applied to the driving wheel; and
wherein the method further comprises applying the creeping torque to the driving wheel sufficient to propel the EV in the drive direction.

13. The method of claim 12, wherein adjusting the creeping torque comprises adjusting the creeping torque to cause the speed of the EV to be constant.

14. The method of claim 10, wherein the method further comprises maintaining the application of the creeping torque absent any time-based threshold determined based on a length of engagement time of the application of the creeping torque.

15. The method of claim 10, wherein the EV further comprises an inclinometer; and
wherein the method further comprises:
detecting an angle of incline of the EV via the inclinometer; and
determining the target creeping speed based on the detected angle of incline.

16. The method of claim 15 further comprising setting a maximum amount of the creeping torque available to be applied to the driving wheel based on the detected angle of incline.

17. An electric vehicle (EV) comprising:
a drive subsystem comprising a drive motor;
a control subsystem comprising:
an accelerator pedal sensor configured to sense a plurality of accelerator pedal positions of an accelerator pedal, the plurality of accelerator pedal positions comprising an accelerator pedal home position and a plurality of accelerator pedal engagement positions;
a brake pedal sensor configured to sense a plurality of brake pedal positions of a brake pedal, the plurality of brake pedal positions comprising a brake pedal home position and a plurality of brake pedal engagement positions; and
a controller configured to:
sense a first accelerator pedal engagement position of the plurality of accelerator pedal engagement positions via the accelerator pedal sensor;
in response to sensing the first accelerator pedal engagement position, cause the drive motor to produce a driving torque sufficient to propel the EV in a drive direction;
sense the brake pedal home position;
sense the accelerator pedal home position;
in response to sensing the brake pedal home position and the accelerator pedal home position, cause the drive motor to produce a creeping torque sufficient to propel the EV in a drive direction; and
adjust the creeping torque to cause the EV to be propelled at a constant creeping speed.

18. The EV of claim 17, wherein the controller is further configured to:
sense a first brake pedal engagement position of the plurality of brake pedal engagement positions; and
in response to sensing the first brake pedal engagement position and the accelerator pedal home position, cause the drive motor to produce a first portion of the creeping torque;
wherein the first portion of the creeping torque is less than the creeping torque; and
wherein the first portion of the creeping torque is sufficient to propel the EV in the drive direction.

19. The EV of claim 18, wherein the controller is further configured to:
sense a second brake pedal engagement position of the plurality of brake pedal engagement positions; and
in response to sensing the second brake pedal engagement position, cause the drive motor to cease producing any torque.

20. The EV of claim 17 further comprising an inclinometer; and
wherein the controller is further configured to:
detect an angle of incline of the EV via the inclinometer; and
set a maximum value of the creeping torque based on the detected angle of incline.
